(19) United States
(12) Patent Application Publication
(10) Pub. No.: US 2023/0374324 A1
(43) Pub. Date: Nov. 23, 2023

(54) A Quantum Dot Ink, a Color Filter Film, a Display Device and a Color Filter Film Preparation Method

(71) Applicant: SUZHOU XINGSHUO NANOTECH CO., LTD., Suzhou, Jiangsu (CN)

(72) Inventors: Yunjun WANG, Suzhou, Jiangsu (CN); Bo MA, Suzhou, Jiangsu (CN)

(21) Appl. No.: 18/027,636

(22) PCT Filed: Nov. 15, 2021
(86) PCT No.: PCT/CN2021/130722

§ 371 Date: Mar. 22, 2023

(30) Foreign Application Priority Data
Sep. 22, 2020 (CN) 202011001726.9

(51) Int. Cl. C09D 11/38; C09D 11/36; C09K 11/07

(52) U.S. Cl. CPC C09D 11/38; C09D 11/36; C09K 11/07

(57) ABSTRACT

The present disclosure provides a quantum dot ink, a color filter film, a display device and a color filter film preparation method, the quantum dot ink comprises quantum dots, siloxane and an acrylate compound, the quantum dot ink contains 1-50 wt % of the quantum dots, 5-50 wt % of the siloxane, and 10-90 wt % of the acrylate compound, wherein the siloxane is used to generate polysiloxane microspheres. When the siloxane is subjected to a reaction, so as to form the polysiloxane microspheres, which may reflect light that is not absorbed in the quantum dots such that the reflected light is re-absorbed in the quantum dots, so as to increase the amount of light absorbed by the quantum dots, thereby improving the light-emitting brightness of a color film prepared and formed in the quantum dot ink, effectively enhancing low utilization of excitation light, and improving a display effect of a display device.

### CROSS-REFERENCE TO RELATED DISCLOSURE

This disclosure claims priority to Chinese Patent priority No. 202011001726.9 filed to the China National Intellectual Property Administration on Sep. 22, 2020 and entitled “A Quantum Dot Ink, a Color Filter Film, a Display Device and a Color Filter Film Preparation Method”, the disclosure of which is hereby incorporated by reference in its entirety.

The present application is a National Stage of International Patent Application No: PCT/CN2021/130722 filed on Nov. 15, 2021, which application claims the benefit of priority to the Chinese patent application No. 202011001726.9 filed on Sep. 22, 2020, which is herein incorporated by reference in their entirety.

### TECHNICAL FIELD

The present disclosure relates to the technical field of display, and specifically, to a quantum dot ink, a color filter film, a display device and a color filter film preparation method.

### BACKGROUND

Quantum dots, also known as semiconductor nanocrystals, are a new type of semiconductor nanomaterials with a size of 1-20 nm, generally. Due to a quantum size effect and a dielectric confinement effect, the quantum dots have unique photoluminescence (PL) and electroluminescence (EL) properties. Compared with traditional organic fluorescent dyes, the quantum dots have excellent optical properties of being high in quantum yield, high in photochemical stability, less susceptible to photolysis, as well as wide excitation, narrow emission, high color purity, and light-emitting color being able to be adjusted by controlling the sizes of quantum dots, such that the quantum dots have wide disclosure prospects in the technical field of display, a quantum dot filter film has become a research hotspot as one of the disclosures with the highest attention at present.

Currently, the quantum dot filter film is mainly prepared by means of an inkjet printing process, that is to say, a quantum dot ink is prepared by dissolving the quantum dots into a resin system, and then the quantum dot filter film is prepared by means of steps of printing and curing the quantum dot ink, in order to improving optical performance, light-diffusing particles are generally added to the quantum dot ink, but this may cause the printing of the quantum dot ink to be not smooth, affecting the stability of the formed quantum dot filter film, even if the light-diffusing particles are dispersed in the ink, the light-diffusing particles are easy to settle in a relatively short period of time, affecting a light diffusion effect.

### SUMMARY

The present disclosure is mainly intended to provide a quantum dot ink, a color filter film, a display device and a color filter film preparation method, to improve the technical problem that the addition of light-diffusing particles into the current quantum dot ink causes poor printing of the quantum dot ink and affects the stability of a quantum dot filter film.

In order to implement the above objective, an aspect of the present disclosure provides a quantum dot ink, which includes quantum dots, siloxane and an acrylate compound.

In the quantum dot ink, by weight percentage, the content of the quantum dots is 1-50 wt %, the content of the siloxane is 5-50 wt %, and the content of the acrylate compound is 10-90 wt %; wherein, the siloxane is used for generating polysiloxane microspheres.

Further, in the quantum dot ink, by weight percentage, the content of the quantum dots is 20-50 wt %, the content of the siloxane is 5-30 wt %, and the content of the acrylate compound is 30-60 wt %.

Further, the boiling point of the acrylate compound is greater than 150° C., and the boiling point of the siloxane is greater than 150° C.

Further, the viscosity of the quantum dot ink at 25° C. is 3-50 cp, such that the activity of the quantum dot ink is improved, the adhesion of the cured color filter film to a base material is enhanced, and film surface hardness and solvent resistance are improved.

Further, the quantum dots contain organic ligand. In the quantum dots, by weight percentage, the content of the organic ligand is 5-60 wt %, preferably 8-50 wt %, and further preferably 10-30 wt %.

Further, the organic ligand includes at least one of oleamine, oleic acid, C6-C18 alkyl mercaptan, triphenylphosphine, triphenylphosphine oxide, sulfhydryl polyethylene glycol, sulfhydryl polyethylene glycol fatty acid ester, sulfhydryl polypropylene glycol, sulfhydryl polypropylene glycol fatty acid ester, sulfhydryl polyglycerol, sulfhydryl polyglycerol fatty acid ester, sulfhydryl-polyoxyethylene (20) dehydrated sorbitol monolaurate, sulfhydryl-polyoxyethylene (20) dehydrated sorbitol stearate, sulfhydryl-polyoxyethylene (20) dehydrated sorbitol oleate, sulfhydryl-polyoxyethylene (20) dehydrated sorbitol palmitate, or sulfhydryl-sorbitan fatty acid ester.

Further, the organic ligand includes at least one of the oleic acid, dodecanethiol or the oleamine. In the organic ligand, by weight percentage, the content of the oleic acid is 20-100 wt %, the content of the oleamine is 0-50 wt %, and the content of the dodecanethiol is 0-50 wt %.

Further, quantum dot main bodies of the quantum dots include at least one of a group II-VI compound, a group III-V compound, a group IV-VI compound, a group I-III-VI compound, a group I-II-IV-VI compound, a perovskite compound or carbon quantum dots.

Further, the particle sizes of the quantum dots are 1-50 nm, preferably 2-35 nm.

Further, the siloxane includes at least one of alkyl siloxane, aminopropyl siloxane, isocyanate-based siloxane, phenyl siloxane, ethenyl siloxane, fluoropropyl siloxane, ethoxysiloxane, cyclosiloxane or silsesquioxane.

Further, the siloxane is selected from at least one of dodecyltriethoxysilane, cyclohexyl ethoxysilane, octaphenylcyclotetrasiloxane, dimethyl cyclosiloxane, methylsilsesquioxane, tetramethylcyclotetrasiloxane, octamethylcyclotetrasiloxane, tetraethoxysilane, aminopropyl-containing siloxane, isocyanate-based siloxane, allyl silsesquioxane, dihydroxy tetradecamethylheptasiloxane, octamethylcyclotetrasiloxane, methylvinylcyclosiloxane, methylphenylcyclotrisiloxane, trifluoropropylmethylcyclotrisiloxane or methylvinylcyclosiloxane, and dimethyl cyclosiloxane, methyl-3,3,5-trifluoropropyl siloxane, phenylsilsesquioxane or dimethylsiloxane.

Further, the acrylate compound includes at least one of methyl acrylate, isobornyl acrylate, propanediol diacrylate or poly(ethylene glycol) diacrylate.

Further, the acrylate compound is selected from at least one of dodecyl methylacrylate, 2-methyl-2-adamantylmethacrylate, isobornyl methacrylate, tripropylene glycol diacrylate, poly(ethylene glycol) diacrylate, or cyclotrimethylolpropane methylal acrylate.

Further, the quantum dot ink further includes an initiator. In the quantum dot ink, by weight percentage, the content of the initiator is 0.1-10 wt %.

Further, the initiator includes photoinitiator and/or thermal initiator.

Further, the photoinitiator is selected from at least one of 2-hydroxy-2-methyl-1-propiophenone, 2-methyl-2-(4-morpholino)-1-[4-(methylthio)phenyl]-1-propanone, 2,4,6-trimethylbenzoylphenylphosphonic acid ethyl ester, 2-dimethylamino-2-benzyl-1-[4-(4-morpholinyl)phenyl]-1-butanone, 2-hydroxy-2-methyl-1-[4-(2-hydroxyethoxy)phenyl]-1-propanone, methyl benzoylformate, 2,4-dihydroxybenzophenone, or diphenyl(2,4,6-trimethylbenzoyl)phosphine oxide.

According to the second aspect of the present disclosure, the present disclosure provides a method for preparing a color filter film, the preparation method includes the following steps:
a, any one of the quantum dot ink is added to a substrate;
b, curing treatment is performed on the quantum dot ink, so as to form a color filter film.

Further, the above-mentioned step b includes: performing light curing on the quantum dot ink, so as to form a prefabricated film, and performing thermal treatment on the prefabricated film, so as to form the color filter film.

Further, the temperature of thermal treatment is 25-300° C., preferably, 80-100° C.

Further, the time for thermal treatment is 30-120 min.

Further, at least some of stages of thermal treatment are completed in an atmosphere containing water vapor.

Further, the atmosphere containing water vapor is an air atmosphere.

Further, the curing treatment is thermal curing, and the temperature of thermal curing is 80-150° C., preferably, 90-125° C.

Further, the time for thermal curing is 60-240 min.

Further, at least some of stages of thermal curing are completed in an atmosphere containing water vapor.

Further, the atmosphere containing water vapor is an air atmosphere.

According to the third aspect of the present disclosure, the present disclosure provides a color filter film, and the color filter film is prepared by the method for preparing a color filter film in the present disclosure.

Further, the color filter film includes polysiloxane microspheres, and the particle sizes of the polysiloxane microspheres are 200-600 nm.

According to the fourth aspect of the present disclosure, the present disclosure provides a display device, and the display device includes the color filter film.

Some embodiments of the present disclosure at least have the following beneficial effects:
(1) The quantum dot ink provided in the present disclosure includes the quantum dots, the siloxane and the acrylate compound; the acrylate compound can dissolve the quantum dots and the siloxane; and then a main body material of a color film is formed after the quantum dot ink is cured. The siloxane is used for generating the polysiloxane microspheres; after the quantum dot ink is printed, the siloxane is subjected to a reaction, so as to form the polysiloxane microspheres, which may reflect light that is not absorbed in the quantum dots such that the reflected light is re-absorbed in the quantum dots, so as to increase the amount of light absorbed by the quantum dots, thereby improving the light-emitting brightness of a color film prepared and formed in the quantum dot ink, effectively enhancing low utilization of excitation light, and improving a display effect of a display device.
(2) In the present disclosure, when the color filter film is prepared, after the quantum dot ink is cured, the siloxane is subjected to the reaction, so as to generate the polysiloxane microspheres having a light-diffusion effect, such that the early addition of the light-diffusing particles may be prevented from causing the problems of easy settling of the quantum dot ink for a short time and difficult storage, and the light-emitting brightness of the color filter film may be significantly improved.
(3) Since the display device of the present disclosure has the color filter film, light-emitting performance is excellent.
(4) The color filter film preparation process and device of the present disclosure are simple, green, environment-friendly, and suitable for industrial production; and the light-diffusing particles are generated after printing, such that the refraction of incident light is effectively increased. Therefore, the present disclosure has profound and lasting significance to promote the industrial development of color filter films, and can generate huge economic and social benefits.

### DESCRIPTION OF THE DRAWINGS

The drawings described herein are used to provide a further understanding of this disclosure, and constitute a part of the present disclosure. The exemplary embodiments and descriptions of the present disclosure are used to explain the present disclosure and do not constitute an improper limitation of the present disclosure. In the drawings:

FIG. 1 is an optical microscope photograph of a color filter film according to Embodiment 1 of the present disclosure.

FIG. 2 is a scanning electron micrograph of generated polysiloxane microspheres according to Embodiment 1 of the present disclosure.

FIG. 3 is an optical microscope photograph of a color filter film according to Comparative example 1 of the present disclosure.

### DETAILED DESCRIPTION OF THE EMBODIMENTS

It is to be noted that the embodiments in this disclosure and the features in the embodiments may be combined with one another without conflict, the present disclosure will now be described below in detail with reference to the drawings and the embodiments.

As described in Background, since the current quantum dot ink contains light-diffusing particles, resulting in poor printing and affecting the stability of a quantum dot filter film, however, the optical performance of the quantum dot ink without light-diffusing particles is relatively poor.

In order to improve printing smoothness of the quantum dot ink and obtain desirable optical performance, the present disclosure provides a quantum dot ink, the quantum dot ink includes quantum dots, siloxane and an acrylate compound, in the quantum dot ink, by weight percentage, the content of the quantum dots is 1-50 wt %, the content of the siloxane is 5-50 wt %, and the content of the acrylate compound is 10-90 wt %, wherein, the siloxane is used for generating polysiloxane microspheres.

In the quantum dot ink of the present disclosure, the acrylate compound can dissolve the quantum dots and the siloxane; and then a main body material of a color filter film (color film for short) is formed after the quantum dot ink is cured, therefore, the quantum dots and the siloxane can be better dissolved in the acrylate compound, the printing smoothness of the quantum dot ink is significantly improved, the light-emitting brightness of the color film formed after curing is increased, and light-emitting uniformity is improved.

After the quantum dot ink provided in the present disclosure is added to a substrate for printing, the siloxane is subjected to a hydrolytic-polymeric reaction, so as to form the polysiloxane microspheres, and the polysiloxane microspheres achieve a light-diffusion effect in the color filter film, specifically, the polysiloxane microspheres in the color filter film refracts excitation light to the quantum dots, such that more excitation light is absorbed and converted by the quantum dots, so as to enhance the light conversion efficiency of the quantum dots in the quantum dot ink, thereby increasing the light utilization of the color filter film, effectively solving the problem of low utilization of the excitation light, and improving a display effect of the display device.

In a preferred implementation of the present disclosure, in the quantum dot ink, by weight percentage, the content of the quantum dots is 20-50 wt %, the content of the siloxane is 5-30 wt %, and the content of the acrylate compound is 30-60 wt %. By means of optimizing the rational proportion of the three substances, the printing smoothness of the quantum dot ink of the present disclosure is further enhanced, and the optical performance of the formed color filter film can be improved.

Typical but non-restrictive, in the quantum dot ink provided in the present disclosure, the content of the quantum dots is, for example, 1 wt %, 2 wt %, 5 wt %, 8 wt %, 10 wt %, 12 wt %, 15 wt %, 18 wt %, 20 wt %, 25 wt %, 30 wt %, 35 wt %, 40 wt %, 45 wt % or 50 wt %; the content of the siloxane is, for example, 5 wt %, 8 wt %, 10 wt %, 12 wt %, 15 wt %, 18 wt %, 20 wt %, 25 wt %, 30 wt %, 35 wt %, 40 wt %, 42 wt %, 45 wt %, 48 wt % or 50 wt %; and the content of the acrylate compound is, for example, 10 wt %, 15 wt %, 20 wt %, 25 wt %, 30 wt %, 35 wt %, 40 wt %, 45 wt %, 50 wt %, 60 wt %, 70 wt %, 80 wt % or 90 wt %.

In a specific implementation of the present disclosure, the boiling point of the acrylate compound is greater than 150° C., and the boiling point of the siloxane is greater than 150° C., such that the acrylate compound effectively forms the main body material of the color filter film by means of curing. In this way, the siloxane can be hydrolyzed with curing and polymerized in the color filter film, so as to form the polysiloxane microspheres, thereby improving the light-emitting brightness of the color filter film.

Optionally, the siloxane in the present disclosure includes, but is not limited to, one of alkyl siloxane, amino propyl siloxane, isocyanate-based siloxane, ethenyl siloxane, fluoropropyl siloxane, ethoxysiloxane, cyclosiloxane or silsesquioxane, or a combination of at least two of the above.

The alkyl in the alkyl siloxane includes, but is not limited to, C1-C14 substituted or non-substituted straight or C3-C14 substituted or non-substituted branched chain alkyl; the aminopropyl siloxane is aminopropyl-containing siloxane; the ethenyl siloxane includes substituted or non-substituted ethenyl siloxane; the ethoxysiloxane includes substituted or non-substituted ethoxysiloxane; the cyclosiloxane includes substituted or non-substituted cyclosiloxane, but is not limited to cyclotrisiloxane or cyclotetrasiloxane; and the silsesquioxane includes substituted or non-substituted silsesquioxane.

In a specific implementation of the present disclosure, the siloxane is selected from one of dodecyltriethoxysilane, cyclohexyl ethoxysilane, octaphenylcyclotetrasiloxane, dimethyl cyclosiloxane, methylsilsesquioxane, tetramethylcyclotetrasiloxane, octamethylcyclotetrasiloxane, tetraethoxysilane, aminopropyl-containing siloxane, isocyanate-based siloxane, allyl silsesquioxane, dihydroxy tetradecamethylheptasiloxane, octamethylcyclotetrasiloxane, methylvinylcyclosiloxane, methylphenylcyclotrisiloxane, trifluoropropylmethylcyclotrisiloxane or methylvinylcyclosiloxane, and dimethyl cyclosiloxane, methyl-3,3,5-trifluoropropyl siloxane, phenylsilsesquioxane or dimethylsiloxane, such that the subsequently-formed polysiloxane microspheres are uniform in particle size, and efficiently refracts the excitation light to the quantum dots, therefore, the light conversion efficiency of the quantum dots is enhanced, and the optical performance of the prepared color filter film is excellent.

Optionally, the acrylate compound includes, but is not limited to, one of methyl acrylate, isobornyl acrylate, propanediol diacrylate or poly(ethylene glycol) diacrylate, or a combination of at least two of the above.

In a specific implementation of the present disclosure, the acrylate compound is selected from one of dodecyl methylacrylate, 2-methyl-2-adamantylmethacrylate, isobornyl methacrylate, tripropylene glycol diacrylate, poly(ethylene glycol) (200) diacrylate, or cyclotrimethylolpropane methylal acrylate, or a combination of at least two of the above, the acrylate compound may not only be effectively subjected to a curing reaction, so as to form the main body material of the quantum dot color film, but also make the quantum dots and the siloxane well dissolved in the acrylate compound, such that the quantum dots in the quantum dot color film formed by means of curing are uniformly dispersed, thereby further improving the light-emitting brightness.

In a preferred implementation of the present disclosure, the viscosity of the quantum dot ink is 3-50 cp, such that the activity of the quantum dot ink is improved, and inkjet printing smoothness may be better; and in addition, the adhesion of the cured color filter film to a base material is enhanced, and film surface hardness and solvent resistance are improved, so as to entirely improve the stability of the color filter film. The viscosity of the quantum dot ink is mainly adjusted by adding proper amount of the acrylate compound and the siloxane.

Typical but non-restrictive, the viscosity of the quantum dot ink is, for example, 3 cp, 5 cp, 8 cp, 10 cp, 15 cp, 20 cp, 25 cp, 30 cp, 35 cp, 40 cp, 45 cp or 50 cp.

In a specific implementation of the present disclosure, the quantum dots contain organic ligand. In the quantum dots, by weight percentage, the content of the organic ligand is 5-60 wt %, such that the quantum dots may be better dispersed in the acrylate compound, so as to make the dispersibility of the quantum dots in the subsequently-obtained color filter film better and make light emission more uniform, the content of the organic ligand is preferably 8-50 wt %, further preferably 10-30 wt %.

Typical but non-restrictive, in the quantum dots, the content of the organic ligand is, for example, 5 wt %, 8 wt %, 10 wt %, 15 wt %, 20 wt %, 25 wt %, 30 wt %, 35 wt %, 40 wt %, 45 wt %, 50 wt %, 55 wt % or 60 wt %.

In a preferred implementation, the organic ligand of the present disclosure includes, but is not limited to, at least one of oleamine, oleic acid, C6-C18 alkyl mercaptan, triphenylphosphine, triphenylphosphine oxide, sulfhydryl polyethylene glycol, sulfhydryl polyethylene glycol fatty acid ester, sulfhydryl polypropylene glycol, sulfhydryl polypropylene glycol fatty acidester, sulfhydryl polyglycerol, sulfhydryl polyglycerol fatty acid ester, sulfhydryl-polyoxyethylene (20) dehydrated sorbitol monolaurate, sulfhydryl-polyoxyethylene (20) dehydrated sorbitol stearate, sulfhydryl-polyoxyethylene (20) dehydrated sorbitol oleate, sulfhydryl-polyoxyethylene (20) dehydrated sorbitol palmitate, or sulfhydryl-sorbitan fatty acid ester, by means of these organic ligands, the quantum dots are better dispersed in the acrylate compound, and slightly acidic and slightly alkaline conditions can be provided for the reaction of the subsequent siloxane in formation of the polysiloxane microspheres, a catalytic reaction is performed, so as to obtain the polysiloxane microspheres with uniform particle sizes, such that the excitation light is effectively refracted to the quantum dots, so as to further improve the brightness of the color filter film.

In some embodiments of the present disclosure, the type of the quantum dots is not particularly limited, as long as the quantum dots can be used for subsequent coordination binding, have a certain luminous performance and can obtain the quantum dots described in the embodiments of the present disclosure.

The quantum dot main bodies of the present disclosure may be obtained by means of preparation of any known methods or may be commercially available, a person skilled in the art may select according to actual requirements of the inkjet printing process or a prepared quantum dot light-emitting device. For example, the quantum dot main bodies of the quantum dots may include a group II-VI compound, a group III-V compound, a group IV-VI compound, a group I-III-VI compound, a group I-II-IV-VI compound, a perovskite compound and carbon quantum dots or a combination thereof. For example, the group II-VI compound may include CdSe, CdTe, ZnS, ZnSe, ZnTe, ZnO, HgS, HgSe, HgTe, MgSe, MgS, CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, HgZnTe, MgZnSe, MgZnS, HgZnTeS, CdZnSeS, CdZnSeTe, CdZnSTe, CdHgSeS, CdHgSeTe, CdHgSTe, HgZnSeS, HgZnSeTe and HgZnSTe or a combination thereof. The group II-VI compound may further include group Ill metal. The group III-V compound may include GaN, GaP, GaAs, GaSb, AlN, AlP, AlAs, AlSb, InN, InP, InAs, InSb, GaNP, GaNAs, GaNSb, GaPAs, GaPSb, AlNP, AlNAs, AlNSb, AlPAs, AlPSb, InNP, InNAs, InNSb, InPAs, InPSb, InZnP, GaAlNP, GaAlNAs, GaAlNSb, GaAlPAs, GaAlPSb, GaInNP, GaInNAs, GalnNSb, GaInPAs, GalnPSb, InAlNP, InAlNAs, InAlNSb, InAlPAs and InAlPSb or a combination thereof. The group III-V compound may further include group II metal (for example, InZnP). The group IV-VI compound may include SnS, SnSe, SnTe, PbS, PbSe, PbTe, SnSeS, SnSeTe, SnSTe, PbSeS, PbSeTe, PbSTe, SnPbS, SnPbSe, SnPbTe, SnPbSSe, SnPbSeTe and SnPbSTe or a combination thereof. An example of the group 1-III-VI compound may include CuInSe2, CuInS2, CuInGaSe and CuInGaS, but is not limited herein. An example of the group I-II-IV-VI compound may include CuZnSnSe and CuZnSnS, but is not limited herein.

The quantum dot main body may further be a core shell structure, for example, the quantum dot main body may include the core of a nanocrystal and a shell which is arranged on at least part of the surface of the nanocrystal and includes a core of which component is different from that of the nanocrystal. At an interface between the core and the shell, an alloyed intermediate layer may or may not exist. The alloyed layer may include homogeneous alloy. In addition, the shell may include a multi-layer shell having at least two layers, and the adjacent layers have different components. In the multi-layer shell, each layer may have a single component. In the multi-layer shell, each layer may have alloy. In the multi-layer shell, each layer may have a concentration gradient which is changed in a radial direction according to the component of the nanocrystal.

In the quantum dots of the core shell structure, the material of the shell may have band gap energy which is greater than band gap energy of the material of the core, but is not limited herein. The material of the shell may have the band gap energy which is less than the band gap energy of the material of the core. In a case of the multi-layer shell, the band gap energy of the outermost material of the shell may be greater than the band gap energy of the material of the core and an inner layer material (which is closer to the layer of the core) of the shell. In the case of the multi-layer shell, the nanocrystal of each layer is selected to have proper band gap energy, such that a quantum confinement effect is effectively displayed.

In addition, the particle size of the quantum dot may range from about 1 nm to about 20 nm. For example, the quantum dot may have the particle size ranging from about 1 nm to about 50 nm, for example, from 2 nm to 35 nm. The shape of the quantum dot is a shape commonly used in the art, and is not specifically limited, such that the corresponding quantum dot may be selected according to actual requirements.

Typical but non-restrictive, the particle size of the quantum dot is, for example, 1 nm, 2 nm, 5 nm, 8 nm, 10 nm, 15 nm, 20 nm, 25 nm, 30 nm, 35 nm, 40 nm, 45 nm or 50 nm. In other implementations of the present disclosure, the quantum dot ink further includes an initiator; the content of the initiator is 0.1 wt %-10 wt %; and the initiator is used for initiating the acrylate compound to undergo polymerization and crosslinking reaction, so as to form a film by means of curing.

The initiator of the present disclosure includes photoinitiator and/or thermal initiator, such that the quantum dot ink may be cured into the film by means of ultraviolet (UV) curing or thermocuring.

In a preferred embodiment, the photoinitiator is selected from at least one of 2-hydroxy-2-methyl-1-propiophenone, 2-methyl-2-(4-morpholino)-1-[4-(methylthio)phenyl]-1-propanone, 2,4,6-trimethylbenzoyl phenylphosphonic acid ethyl ester, 2-dimethylamino-2-benzyl-1-[4-(4-morpholinyl)phenyl]-1-butanone, 2-hydroxy-2-methyl-1-[4-(2-hydroxyethoxy)phenyl]-1-propanone, methyl benzoylformate, 2,4-dihydroxybenzophenone, or diphenyl(2,4,6-trimethylbenzoyl)phosphine oxide, the photoinitiator is used for absorbing energy of a certain wavelength in a UV area when UV curing is used, so as to generate free radicals and cations, thereby initiating a monomer for polymerization, crosslinking and curing, the photoinitiator effectively promotes the crosslinking and curing of the acrylate compound, the thermal initiator is selected from one or more of azo, peroxide, persulfate and redox initiator.

In a preferred implementation of the present disclosure, the quantum dot ink further includes a leveling agent, the leveling agent may be selected from a combination of any one or more of poly(dimethylsiloxane), polymethylphenylsiloxane, acrylic resin, urea-formaldehyde resin and melamine formaldehyde resin, the leveling agent facilitates the leveling of the quantum dot ink after inkjet, so as to ensure that the quantum dot ink is relatively flat at a film formation stage, such that light is uniformly dispersed when passing through a quantum dot film, and the display effect is uniform, thereby making a display panel having a better display effect.

In another preferred implementation of the present disclosure, the quantum dot ink further includes a defoaming agent, the defoaming agent is used for reducing the surface tension of the quantum dot ink, so as to inhibit the production of bubbles, or eliminate original bubbles as soon as possible, such that the flatness of the formed color filter film is improved. The defoaming agent may be selected from any one of an alkane solvent, an aromatic hydrocarbon solvent, esters solvent with the number of main-chain carbon atoms≥4, a ketone solvent and an ether solvent.

In still another preferred implementation of the present disclosure, the quantum dot ink further includes a polymerization inhibitor, and the polymerization inhibitor is used for inhibiting crosslinking at room temperature during exposure after the quantum dot ink is printed, so as to effectively inhibit the deterioration of the quantum dot color film. The content of the polymerization inhibitor is, for example, 0.001-0.05 wt %. The polymerization inhibitor may be selected from at least one of hydroquinone, 4-methoxyphenol, di-tert-butyl-p-cresol, pyrogallol, tert-butylcatechol, benzoquinone, 4,4′-thiobis(3-methyl-6-tert-butyl benzoic acid), 2,2′-methylenebis(6-tert-butyl-4-methylphenol), N-nitrosophenyl hydroxyamine first cerium salt, phenothiazine, phenoxazine, 4-methoxy-1-naphthol, 2,2,6,6-tetramethylpiperidin-1-oxyl radical, 2,2,6,6-tetramethylpiperidine, 4-hydroxy-2,2,6,6-tetramethyl-piperidin-1-oxyl radical, nitrobenzene or dimethylaniline.

The quantum dot ink of the present disclosure may further include a solvent, the solvent may be selected from conventional solvents in the quantum dot ink; definitely, the quantum dot ink of the present disclosure may not include the solvent, the quantum dots in the quantum dot ink of the present disclosure have good solubility; and the acrylate compound, the siloxane and additives have met smoothness requirements of the quantum dot ink under a printing condition, such that no additional solvent may be added, thereby preventing the color filter film from shrinking.

The present disclosure further provides a method for preparing a color filter film, the preparation method includes the following steps:
a, the quantum dot ink is added to a substrate;

The mode of adding the ink includes any one of inkjet or coating or a combination thereof, in an inkjet printing method, it may be expected that the thickness of the quantum dot ink printed on a base is 0.5 μm-15 μm. An inkjet spraying method may be performed by means of spraying a single color, or may be performed by means of simultaneously spraying different colors, and the present disclosure is not limited thereto, as long as the quantum dot ink is added to the substrate, the protection scope of the present disclosure is met.
b, curing treatment is performed on the quantum dot ink, so as to form a color filter film.

In some embodiments, the curing treatment includes at least the following two specific implementations.

In the first curing treatment, the curing treatment includes light curing and thermal treatment.

Specifically, step b includes b1-b2;
b1, light curing is performed on the quantum dot ink, so as to form a prefabricated film;
the quantum dot ink is cured so as to form the prefabricated film, the UV wavelength, energy and time of UV curing in the present disclosure may be selected according to actual requirements, and the present disclosure is not limited thereto.
b2, thermal treatment is performed on the prefabricated film, so as to form the color filter film.

Thermal treatment may effectively remove residual low-boiling point substances such as the acrylate compound, so as to further improve the light-emitting performance of the color filter film, thermal treatment may further effectively promote the hydrolytic-polymeric reaction of the siloxane, so as to generate the polysiloxane microspheres having the light-diffusion effect, such that the light-emitting efficiency of the prepared color filter film is significantly improved.

In a specific implementation of the present disclosure, the temperature of thermal treatment is between 25° C. and 110° C., preferably between 80° C. and 100° C., such that the particle size of the self-generated polysiloxane microspheres may be effectively controlled at an appropriate range.

Typical but non-restrictive, the temperature of thermal treatment is, for example, 25° C., 30° C., 40° C., 50° C., 60° C., 70° C., 80° C., 90° C., 100° C., or 110° C.

In a specific implementation of the present disclosure, the time for thermal treatment is between 30 and 120 min, so as to facilitate the reaction of the siloxane to generate the polysiloxane microspheres to be undergone more completely.

Typical but non-restrictive, the time for thermal treatment is, for example, 30 min, 40 min, 50 min, 80 min, 100 min or 120 min.

In a preferred implementation of the present disclosure, at least some of stages of thermal treatment are completed in an environment containing water vapor, the environment containing water vapor may make the siloxane subjected to the hydrolytic-polymeric reaction under a micro-aqueous condition, so as to generate the polysiloxane microspheres having the light-diffusion effect, thereby improving the optical performance of the color filter film.

In a more preferred implementation of the present disclosure, the environment containing water vapor is an air atmosphere, under the air atmosphere, the siloxane is subjected to the hydrolytic-polymeric reaction with thermal treatment, so as to form the polysiloxane microspheres, such that requirements for production devices are simple, high-temperature and high-pressure devices are not required, and a production process of the color filter film is effectively simplified.

In the second curing treatment, the curing treatment is thermocuring.

Specifically, in step b, thermocuring is performed on the quantum dot ink, so as to form the color filter film.

In a specific implementation, the temperature of thermocuring is 80-150° C., such that the acrylate compound is cured to form the main body material of the color filter film, and at the same time, the siloxane is subjected to the reaction so as to form the polysiloxane microspheres, the temperature is preferably 90-125° C., such that the curing reaction of the acrylate compound and the reaction of the siloxane for generating the polysiloxane microspheres are higher in efficiency and lower in energy consumption.

Typical but non-restrictive, the temperature of thermocuring is, for example, 80° C., 90° C., 100° C., 110° C., 120° C., 130° C., 140° C., or 150° C.

In preferred implementation, the time for thermocuring is 60-240 min, so as to make the quantum dot ink completely cured.

Typical but non-restrictive, the time for thermocuring is, for example, 60 min, 80 min, 100 min, 120 min, 150 min, 180 min, 200 min, 220 min or 240 min.

Optionally, at least some of stages of thermocuring are completed in an atmosphere containing water vapor, and the environment containing water vapor may make the siloxane subjected to the hydrolytic-polymeric reaction under a micro-aqueous condition, so as to generate the polysiloxane microspheres having the light-diffusion effect, thereby improving the optical performance of the color filter film.

More optionally, the atmosphere containing water vapor is an air atmosphere, under the air atmosphere, the siloxane is subjected to the hydrolytic-polymeric reaction with thermocuring, so as to form the polysiloxane microspheres, such that requirements for production devices are simple, high-temperature and high-pressure devices are not required, and a production process of the color filter film is effectively simplified.

It is understandable that, the siloxane of the present disclosure in the quantum dot ink is in a liquid state; and under a certain condition after printing, the siloxane may be subjected to the reaction to form the polysiloxane microspheres, and the polysiloxane microspheres are in a solid state.

In the method for preparing a color filter film of the present disclosure, after the quantum dot ink is printed, the polysiloxane microspheres are self-generated, such that the preparation process and device are simple, green, environment-friendly, and suitable for industrial production; and the refraction of incident light is effectively increased, therefore, the present disclosure has profound and lasting significance to promote the industrial development of color filter films, and can generate huge economic and social benefits.

In a preferred implementation of the present disclosure, the particle sizes of the polysiloxane microspheres are 200-600 nm, so as to increase the optical path of the excitation light in a film layer, thereby improving a brightness conversion rate of the quantum dots in the ink.

Typical but non-restrictive, the particle size of the polysiloxane microsphere is, for example, 200 nm, 250 nm, 300 nm, 350 nm, 400 nm, 450 nm, 500 nm, 550 nm or 600 nm.

In another preferred implementation of the present disclosure, the thickness of the color filter film is 8-15 μm, such that the flatness of the film surface is better, and the thickness of the film layer is more uniform, thereby improving the light-emitting efficiency of the color filter film and obtaining excellent optical performance.

Typical but non-restrictive, the thickness of the color filter film is, for example, 8 μm, 10 μm, 12 μm or 15 μm.

The present disclosure further provides a display device, and the display device includes the color filter film. The display device of the present disclosure includes, but is not limited to, any product or component having a display function, such as an electronic paper, a mobile phone, a tablet computer, a television, a display, a notebook computer, a digital photo frame, a navigator, a vehicle display, an AR display and a VR display, especially suitable for a color display device, as the color filter film is used, the display device of the present disclosure has excellent light-emitting performance.

In addition to having the color filter film, the display device of the present disclosure may further include structures known to those skilled in the art, for example, a electroluminescent diode, a touch-control panel and a packaging cover plate.

In a preferred implementation, in the display device of the present disclosure, the light entry side of the color filter film is of an arcuate structure, such that the scattering of the incident light is further increased, thereby improving the optical performance of the display device.

The quantum dot ink and the display device are described below in more detail according to some exemplary embodiments of the present disclosure; however, the exemplary embodiments of the present disclosure are not limited thereto.

### Embodiment 1

Step S1, the following weight percentage referred to the weight percentage of each substance in the quantum dot ink; 23.1 wt % of green-light CdSe/ZnS quantum dots, 23.7 wt % of n-dodecyltriethoxysilane, 24.2 wt % of triethylene glycol dimethacrylate and 23.2 wt % of pentaerythritol tetraacrylate were added to a brown bottle, and placed in a 45° C. ultrasonator to perform oscillation for 30 min, so as to completely dissolved the green-light CdSe/ZnS quantum dots; wherein the green-light CdSe/ZnS quantum dots included organic ligand, the content of the organic ligand accounted for 12 wt % of that of the quantum dots; and the organic ligand included 7 wt % of oleic acid, 2 wt % of dodecanethiol (DDT) and 3 wt % of oleylamine.

Step S2, 3.8 wt % of 2-hydroxy-2-methylpropiophenone, 0.8 wt % of a BYK-361 N leveling agent, 0.4 wt % of a BYK-1790 defoaming agent and 0.8 wt % of butylated hydroxytoluene were added to the brown bottle in S1; then the brown bottle was placed in the 45° C. ultrasonator to perform oscillation for 30 min, so as to guarantee the added additives to be completely dissolved; and the quantum dot ink with the viscosity being 9.1 cp at 25° C. after uniform stirring.

Step S3, a glass substrate provided with a plurality of pixel isolation structures was prepared; inkjet printing of the aforementioned quantum dot ink, the smoothness and stability of inkjet printing were excellent; and then UV curing was performed at 3000 mJ/cm² by using UV light with the wavelength being 365 nm, so as to form a prefabricated film.

Step S4, the prefabricated film was heated for 60 min and a heating temperature was 80° C.; and a color filter film with the thickness being 8.2 μm was obtained after drying.

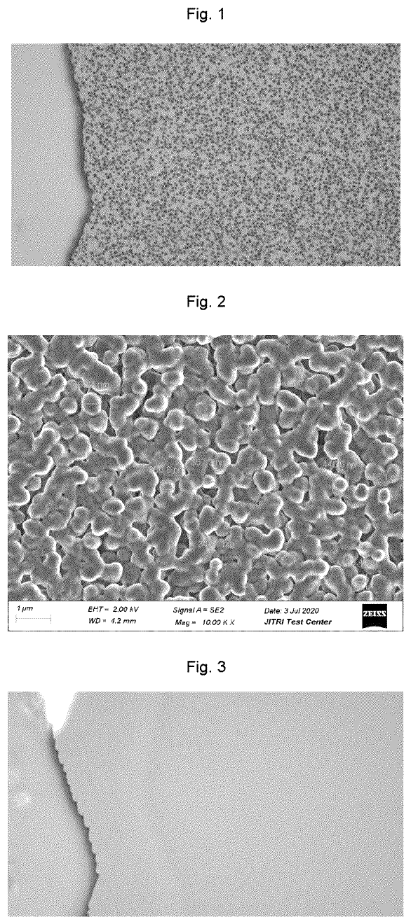

FIG. 1 is an optical microscope photograph of a color filter film according to Embodiment 1 of the present disclosure; FIG. 2 is a scanning electron micrograph of generated polysiloxane microspheres according to Embodiment 1 of the present disclosure; under an optical microscope, it can be seen from FIG. 1 that there are many self-generated polysiloxane microspheres on the film surface of the color filter film; and it can be seen from FIG. 2 that the particle sizes of the polysiloxane microspheres are between 300 and 600 nm, such that the particles are uniform. It can be seen from FIG. 2 that there are pores between the polysiloxane microspheres, i. e. in the process of self-generating the polysiloxane microspheres, the pores are formed by dispersing between the polysiloxane microspheres, so that light is not only scattered on the polysiloxane microspheres, but also refracted in the pores, and thus a color filter film with a higher light conversion efficiency is obtained.

### Embodiment 2

Step S1, the following weight percentage referred to the weight percentage of each substance in the quantum dot ink; 17.8 wt % of cyclohexyldimethoxymethylsilane and 53.4 wt % of trimethylolpropane trimethacrylate were added to a brown bottle containing 23.1 wt % of green-light CdSe/ZnS quantum dots, and placed in a 45° C. ultrasonator to perform oscillation for 30 min, so as to completely dissolved the green-light CdSe/ZnS quantum dots; wherein the green-light CdSe/ZnS quantum dots include organic ligand, the content of the organic ligand accounted for 15 wt % of that of the quantum dots; and the organic ligand included 10 wt % of oleic acid, 2 wt % of DDT and 3 wt % of oleylamine.

Step S2, 2.0 wt % of trimethylbenzoyldiphenyl phosphine oxide, 1.8 wt % of 2-isopropylthioxanthone, 0.8 wt % of a BYK-3441 leveling agent, 0.4 wt % of a BYK-1798 defoaming agent and 0.8 wt % of 2-methylhydroquinone were added to the brown bottle in S1; then the brown bottle was placed in the 45° C. ultrasonator to perform oscillation for 30 min, so as to guarantee the added additives to be completely dissolved; and the quantum dot ink with the viscosity being 10.4 cp at 25° C. after uniform stirring.

Step S3, a glass substrate provided with a plurality of pixel isolation structures was prepared; inkjet printing of the aforementioned quantum dot ink, the smoothness and stability of inkjet printing were excellent; and then UV curing was performed at 2000 mJ/cm² by using UV light with the wavelength being 365 nm, so as to form a prefabricated film.

Step S4, the prefabricated film was heated for 50 min and a heating temperature was 100° C.; and a color filter film with the thickness being 9.4 μm was obtained after drying.

### Embodiment 3

Step S1, the following weight percentage referred to the weight percentage of each substance in the quantum dot ink; 14.2 wt % of cyclohexyldimethoxymethylsilane and 56.9 wt % of tri(propylene glycol) diacrylate were added to a brown bottle containing 23.1 wt % of green-light CdSe/ZnS quantum dots, and placed in a ultrasonator to perform oscillation for 30 min, so as to completely dissolved the green-light CdSe/ZnS quantum dots; wherein the green-light CdSe/ZnS quantum dots include organic ligand, the content of the organic ligand accounted for 20 wt % of that of the quantum dots; and the organic ligand included 4 wt % of DDT and 16 wt % of oleylamine.

Step S2, 3.8 wt % of 2-methyl-2-(4-morpholino)-1-[4-(methylthio)phenyl]-1-propanone, 0.8 wt % of a BYK-3455 leveling agent, 0.4 wt % of a BYK-A535 defoaming agent and 0.8 wt % of thiodiphenylamine were added to the brown bottle in S1; then the brown bottle was placed in the 45° C. ultrasonator to perform oscillation for 30 min, so as to guarantee the added additives to be completely dissolved; and the quantum dot ink with the viscosity being 10.5 cp at 25° C. after uniform stirring.

Step S3, a glass substrate provided with a plurality of pixel isolation structures was prepared; inkjet printing of the aforementioned quantum dot ink; and then UV curing was performed on the quantum dot ink at 4000 mJ/cm² by using UV light with the wavelength being 365 nm, so as to form a prefabricated film.

Step S4, the prefabricated film was heated for 120 min, and a heating temperature was 25° C.; and a color filter film with the thickness being 9.1 μm was obtained after drying.

### Embodiment 4

Step S1, the following weight percentage referred to the weight percentage of each substance in the quantum dot ink; 11.9 wt % of methylvinylcyclosiloxane and 59.3 wt % of polyethylene glycol (200) diacrylate were added to a brown bottle containing 23.1 wt % of green-light CdSe/ZnS quantum dots, and placed in a 45° C. ultrasonator to perform oscillation for 30 min, so as to completely dissolved the green-light CdSe/ZnS quantum dots; wherein the green-light CdSe/ZnS quantum dots include organic ligand, the content of the organic ligand accounted for 30 wt % of that of the quantum dots; and the organic ligand included 24 wt % of oleic acid and 6 wt % of DDT.

Step S2, 1.9 wt % of trimethylbenzoyldiphenyl phosphine oxide, 1.8 wt % of 2-isopropylthioxanthone, 0.8 wt % of a BYK-361N leveling agent, 0.4 wt % of a BYK-1790 defoaming agent and 0.8 wt % of p-hydroxyanisole were added to the brown bottle in S1; then the brown bottle was placed in the 45° C. ultrasonator to perform oscillation for 30 min, so as to guarantee the added additives to be completely dissolved; and the quantum dot ink with the viscosity being 9.8 cp at 25° C. after uniform stirring.

Step S3, a glass substrate provided with a plurality of pixel isolation structures was prepared; inkjet printing of the aforementioned quantum dot ink; and then UV curing was performed on the quantum dot ink at 5000 mJ/cm² by using UV light with the wavelength being 365 nm, so as to form a prefabricated film.

Step S4, the prefabricated film was heated for 100 min and a heating temperature was 50° C.; and a color filter film with the thickness being 10.2 μm was obtained after drying.

### Embodiment 5

Step S1, the following weight percentage referred to the weight percentage of each substance in the quantum dot ink; 10.2 wt % of methylphenylcyclosiloxane and 60.1 wt % of isobornyl methacrylate were added to a brown bottle containing 23.1 wt % of green-light CdSe/ZnS quantum dots, and placed in a 45° C. ultrasonator to perform oscillation for 30 min, so as to completely dissolved the green-light CdSeIZnS quantum dots; wherein the green-light CdSeIZnS quantum dots included organic ligand, the content of the organic ligand accounted for 50 wt % of that of the quantum dots; and the organic ligand included 30 wt % of oleic acid, 4 wt % of DDT and 16 wt % of oleylamine.

Step S2, 3.8 wt % of dicumyl peroxide, 0.7 wt % of a BYK-3441 leveling agent, 0.4 wt % of a BYK-1798 defoaming agent and 0.8 wt % of 2-methylhydroquinone were added to the brown bottle in S1; then the brown bottle was placed in the 45° C. ultrasonator to perform oscillation for 30 min, so as to guarantee the added additives to be completely dissolved; and the quantum dot ink with the viscosity being 10.1 cp at 25° C. after uniform stirring.

Step S3, a glass substrate provided with a plurality of pixel isolation structures was prepared; and inkjet printing of the aforementioned quantum dot ink, and the smoothness and stability of inkjet printing were excellent.

Step S4, the substrate on which the quantum dot ink was printed was heated for 80 min, and a heating temperature was 120° C.; and a color filter film with the thickness being 8.7 μm was obtained after drying.

### Embodiment 6

This embodiment provided a color filter film, the difference between this embodiment and Embodiment 1 lied in that, in a quantum dot ink, by weight percentage, the content of quantum dots was 1 wt %; the content of dodecyltriethoxysilane was 5 wt %; the content of pentaerythracrylate is 45 wt %; the content of pentaerythritol tetraacrylate is 45 wt %; the content of 2-hydroxy-2-methyl-1-phenylacetone was 2.5 wt %; the content of a BYK-361 N leveling agent was 0.5 wt %; the content of a BYK-1790 defoaming agent was 0.4 wt %; and the content of butylated hydroxytoluene was 0.6 wt %, raw materials in this embodiment belonged to the same batch as Embodiment 1, a preparation method and used related excipients were all the same as Embodiment 1, and details were not described herein again.

### Embodiment 7

This embodiment provided a color filter film, the difference between this embodiment and Embodiment 1 lied in that, in a quantum dot ink, by weight percentage, the content of quantum dots was 50 wt %; the content of dodecyltriethoxysilane was 34.2 wt %; the content of triethylene glycol dimethacrylate was 5 wt %; and the content of pentaerythracrylate was 5 wt %, raw materials in this embodiment belonged to the same batch as Embodiment 1, a preparation method and used related additives and excipients were all the same as Embodiment 1, and details were not described herein again.

### Embodiment 8

This embodiment provided a color filter film, the difference between this embodiment and Embodiment 1 lied in that, in a quantum dot ink, by weight percentage, the content of quantum dots was 14.2 wt %; the content of dodecyltriethoxysilane was 50 wt %; the content of triethylene glycol dimethacrylate was 15 wt %; and the content of pentaerythracrylate was 15 wt %, raw materials in this embodiment belonged to the same batch as Embodiment 1, a preparation method and used related additives and excipients were all the same as Embodiment 1, and details were not described herein again.

### Embodiment 9

This embodiment provided a color filter film, the difference between this embodiment and Embodiment 1 lied in that, in a quantum dot ink, by weight percentage, the content of quantum dots was 29.2 wt %; the content of dodecyltriethoxysilane was 40 wt %; the content of triethylene glycol dimethacrylate was 15 wt %; and the content of pentaerythracrylate was 10 wt %, raw materials in this embodiment belonged to the same batch as Embodiment 1, a preparation method and used related additives and excipients were all the same as Embodiment 1, and details were not described herein again.

### Embodiment 10

This embodiment provided a color filter film, the difference between this embodiment and Embodiment 1 lied in that, in a quantum dot ink, by weight percentage, the content of quantum dots was 10.2 wt %; the content of dodecyltriethoxysilane was 9 wt %; the content of triethylene glycol dimethacrylate was 45 wt %; and the content of pentaerythracrylate was 30 wt %, raw materials in this embodiment belonged to the same batch as Embodiment 1, a preparation method and used related additives and excipients were all the same as Embodiment 1, and details were not described herein again.

### Embodiment 11

This embodiment provided a color filter film, the difference between this embodiment and Embodiment 1 lied in that, in a quantum dot ink, by weight percentage, the content of quantum dots was 20 wt %; the content of dodecyltriethoxysilane was 15 wt %; the content of methylsilsesquioxane was 15 wt %; the content of triethylene glycol dimethacrylate was 23.2 wt %; and the content of pentaerythracrylate was 21 wt %, raw materials in this embodiment belonged to the same batch as Embodiment 1, a preparation method and used related additives and excipients were all the same as Embodiment 1, and details were not described herein again.

### Embodiment 12

This embodiment provided a color filter film, the difference between this embodiment and Embodiment 1 lied in that, in a quantum dot ink, by weight percentage, the content of quantum dots was 24.2 wt %; the content of dodecyltriethoxysilane was 20 wt %; the content of octamethylcyclotetrasiloxane was 10 wt %; the content of triethylene glycol dimethacrylate was 21 wt %; and the content of pentaerythracrylate was 19 wt %, raw materials in this embodiment belonged to the same batch as Embodiment 1, a preparation method and used related additives and excipients were all the same as Embodiment 1, and details were not described herein again.

### Embodiment 13

This embodiment provided a color filter film, the difference between this embodiment and Embodiment 1 lied in that, in a quantum dot ink, by weight percentage, the content of quantum dots was 29.2 wt %; the content of dodecyltriethoxysilane was 2 wt %; the content of isocyanate-based siloxane was 3 wt %; the content of triethylene glycol dimethacrylate was 30 wt %; and the content of pentaerythracrylate was 30 wt %, raw materials in this embodiment belonged to the same batch as Embodiment 1, a preparation method and used related additives and excipients were all the same as Embodiment 1, and details were not described herein again.

### Embodiment 14

This embodiment provided a color filter film, the difference between this embodiment and Embodiment 1 lied in that, in green-light CdSe/ZnS quantum dots, the content of organic ligand accounted for 8 wt % of that of quantum dots; the organic ligand included 4 wt % of oleic acid, 2 wt % of DDT and 2 wt % of oleylamine; and remaining raw materials, a preparation method and used related additives and excipients were all the same as Embodiment 1, and details were not described herein again.

### Embodiment 15

This embodiment provided a color filter film, the difference between this embodiment and Embodiment 1 lied in that, in green-light CdSe/ZnS quantum dots, the content of organic ligand accounted for 50 wt % of that of quantum dots; the organic ligand included 30 wt % of oleic acid, 12 wt % of DDT and 18 wt % of oleylamine; and remaining raw materials, a preparation method and used related additives and excipients were all the same as Embodiment 1, and details were not described herein again.

### Embodiment 16

This embodiment provided a color filter film, the difference between this embodiment and Embodiment 1 lied in that, in green-light CdSe/ZnS quantum dots, the content of organic ligand accounted for 10 wt % of that of quantum dots; the organic ligand included 5 wt % of oleic acid, 2 wt % of DDT and 3 wt % of oleylamine; and remaining raw materials, a preparation method and used related additives and excipients were all the same as Embodiment 1, and details were not described herein again.

### Embodiment 17

This embodiment provided a color filter film, the difference between this embodiment and Embodiment 1 lied in that, in green-light CdSe/ZnS quantum dots, the content of organic ligand accounted for 30 wt % of that of quantum dots; the organic ligand included 20 wt % of oleic acid, 4 wt % of DDT and 6 wt % of oleylamine; and remaining raw materials, a preparation method and used related additives and excipients were all the same as Embodiment 1, and details were not described herein again.

### Embodiment 18

This embodiment provided a color filter film, the difference between this embodiment and Embodiment 1 lied in that, in green-light CdSe/ZnS quantum dots, the content of organic ligand accounted for 60 wt % of that of quantum dots; the organic ligand included 35 wt % of oleic acid, 10 wt % of DDT and 15 wt % of oleylamine; and remaining raw materials, a preparation method and used related additives and excipients were all the same as Embodiment 1, and details were not described herein again.

### Embodiment 19

This embodiment provided a color filter film, the difference between this embodiment and Embodiment 1 lied in that, in green-light CdSe/ZnS quantum dots, the content of organic ligand accounted for 12 wt % of that of quantum dots; the organic ligand included 4.8 wt % of oleic acid, 1.2 wt % of DDT and 6 wt % of oleylamine; and remaining raw materials, a preparation method and used related additives and excipients were all the same as Embodiment 1, and details were not described herein again.

### Embodiment 20

This embodiment provided a color filter film, the difference between this embodiment and Embodiment 1 lied in that, in green-light CdSe/ZnS quantum dots, the content of organic ligand accounted for 12 wt % of that of quantum dots; the organic ligand included 6 wt % of oleic acid and 6 wt % of DDT; and remaining raw materials, a preparation method and used related additives and excipients were all the same as Embodiment 1, and details were not described herein again.

### Embodiment 21

This embodiment provided a color filter film, the difference between this embodiment and Embodiment 1 lied in that, green-light CdSe/ZnS quantum dots were replaced with green-light cesium lead bromide perovskite quantum dots.

### Embodiment 22

This embodiment provided a color filter film, the difference between this embodiment and Embodiment 1 lied in that, green-light CdSe/ZnS quantum dots were replaced with green-light InP/ZnS quantum dots.

### Comparative Example 1

Step S1, the following weight percentage referred to the weight percentage of each substance in the quantum dot ink; 71.1 wt % of triethylene glycol dimethacrylate was added to a brown bottle containing 23.1 wt % of green-light CdSe/ZnS quantum dots, and placed in a 45° C. ultrasonator to perform oscillation for 30 min, so as to completely dissolved the green-light CdSe/ZnS quantum dots; the green-light CdSe/ZnS quantum dots included organic ligand, the content of the organic ligand accounted for 20 wt % of that of the quantum dots; and the organic ligand included 10 wt % of oleic acid, 4 wt % of DDT and 6 wt % of oleylamine.

Step S2, 3.8 wt % of trimethylbenzoyldiphenyl phosphine oxide, 0.8 wt % of a BYK-3455 leveling agent, 0.4 wt % of a BYK-A535 defoaming agent and 0.8 wt % of thiodiphenylamine were added to the brown bottle in S1; then the brown bottle was placed in the 45° C. ultrasonator to perform oscillation for 30 min, so as to guarantee the added additives to be completely dissolved; and the quantum dot ink with the viscosity being 10.4 cp at 25° C. after uniform stirring.

Step S3, a glass substrate provided with a plurality of pixel isolation structures was prepared; inkjet printing of the aforementioned quantum dot ink, the smoothness and stability of inkjet printing were excellent; and then UV curing was performed at 2000 mJ/cm² by using UV light with the wavelength being 365 nm, so as to form a prefabricated film.

Step S4, the prefabricated film was heated for 120 min and a heating temperature was 25° C.; and a color filter film with the thickness being 9.3 μm was obtained after drying.

FIG. 3 was an optical microscope photograph of a color filter film according to Comparative example 1 of the present disclosure. As shown in FIG. 3, under an optical microscope, it can be seen that the surface of the color filter film was smooth and had no microsphere.

### Comparative Example 2

Comparative example 2 provided a color filter film, the difference between this embodiment and Embodiment 1 lied in that, in a quantum dot ink, by weight percentage, the content of quantum dots was 24.2 wt %; the content of n-dodecyltriethoxysilane was 3 wt %; the content of triethylene glycol dimethacrylate was 30 wt %; and the content of pentaerythracrylate was 27 wt %, raw materials in this embodiment belonged to the same batch as Embodiment 1, a preparation method and used related additives and excipients were all the same as Embodiment 1, and details were not described herein again.

### Comparative Example 3

Comparative example 3 provided a color filter film, the difference between this embodiment and Embodiment 1 lied in that, in a quantum dot ink, by weight percentage, the content of quantum dots was 4.2 wt %; the content of dodecyltriethoxysilane was 60 wt %; the content of triethylene glycol dimethacrylate was 15 wt %; and the content of pentaerythritol tetraacrylate was 15 wt %, raw materials in this embodiment belonged to the same batch as Embodiment 1, a preparation method and used related additives and excipients were all the same as Embodiment 1, and details were not described herein again.

### Comparative Example 4

Comparative example 4 provided a color filter film, the difference between this embodiment and Embodiment 1 lied in that, in a quantum dot ink, by weight percentage, the content of quantum dots was 3 wt %; the content of dodecyltriethoxysilane was 5 wt %; the content of triethylene glycol dimethacrylate was 47 wt %; and the content of pentaerythracrylate was 45 wt %, raw materials in this embodiment belonged to the same batch as Embodiment 1, a preparation method and used related additives and excipients were all the same as Embodiment 1, and details were not described herein again.

The color filter film provided in the embodiments and the comparative examples were irradiated by using a blue backlight source, an optical color analyzer was used to separately test the light-emitting brightness of green light emitted in the embodiments and the comparative examples, a test device was a PR-670 fluorescence spectrometer, the test backlight intensity was 1000 nits, and the pixel aperture rate of the glass substrate was 30.8%, there was also a blue filter layer between the glass substrate and the color filter film, the blue filter layer filters blue light that was not absorbed by the quantum dots, and results were shown in Table 1.

TABLE 1
Optical performance result of embodiments
and comparative examples

| | Test item |
|---|---|
| | Light-emitting |
| | brightness |
| | (cd/m²) of green |
| Embodiment | light |
| Embodiment 1 | 143 |
| Embodiment 2 | 131 |
| Embodiment 3 | 119 |
| Embodiment 4 | 110 |
| Embodiment 5 | 103 |
| Embodiment 6 | 8 |
| Embodiment 7 | 118 |
| Embodiment 8 | 80 |
| Embodiment 9 | 91 |
| Embodiment 10 | 70 |
| Embodiment 11 | 112 |
| Embodiment 12 | 120 |
| Embodiment 13 | 95 |
| Embodiment 14 | 140 |
| Embodiment 15 | 132 |
| Embodiment 16 | 145 |
| Embodiment 17 | 146 |
| Embodiment 18 | 128 |
| Embodiment 19 | 138 |
| Embodiment 20 | 146 |
| Embodiment 21 | 120 |
| Embodiment 22 | 80 |
| Comparative example 1 | 82 |
| Comparative example 2 | 87 |
| Comparative example 3 | 16 |
| Comparative example 4 | 12 |

It can be learned from Table 1 that, compared with Comparative examples 1-4, the color filter film prepared by the quantum dot ink according to Embodiments 1-5, Embodiment 7, Embodiment 9 and Embodiments 11-20 of the present disclosure may obtain better light-emitting brightness, such that it can be learned that the quantum dots of the quantum dot ink of the present disclosure had good solubility, the prepared color filter film had high light-emitting brightness, a light conversion effect was good, and light-emitting performance was excellent.

In Embodiment 6, Embodiment 8 and Embodiment 10, since the content of the quantum dots was low, the light-emitting brightness of the quantum dots was relatively low, in Embodiment 13, since the use amount of the siloxane was relatively low, the light-emitting brightness of the siloxane was relatively low, different types of the quantum dots were used in Embodiments 21-22, resulting in relatively low light-emitting brightness.

The above are only the preferred embodiments of this disclosure and are not intended to limit this disclosure, for those skilled in the art, this disclosure may have various modifications and variations. Any modifications, equivalent replacements, improvements and the like made within the spirit and principle of this disclosure shall fall within the scope of protection of this disclosure.

### INDUSTRIAL APPLICABILITY

The solutions provided in the embodiments of the present disclosure may be applied to the technical field of display, after the quantum dot ink provided in the present disclosure is printed, the siloxane is subjected to a reaction, so as to form the polysiloxane microspheres, which may reflect light that is not absorbed in the quantum dots such that the reflected light is re-absorbed in the quantum dots, so as to increase the amount of light absorbed by the quantum dots, thereby improving the light-emitting brightness of the color film prepared and formed in the quantum dot ink, enhancing the excitation light utilization efficiency, and improving a display effect of a display device.

1. A quantum dot ink, comprising quantum dots and siloxane, wherein the siloxane is used for generating polysiloxane microspheres.

2. The quantum dot ink according to claim 1, the quantum dot ink further comprising an acrylate compound, wherein
in the quantum dot ink, by weight percentage, the content of the quantum dots is 1-50 wt %, the content of the siloxane is 5-50 wt %, and the content of the acrylate compound is 10-90 wt %, wherein the siloxane is used for generating polysiloxane microspheres; and
optionally, in the quantum dot ink, by weight percentage, the content of the quantum dots is 20-50 wt %, the content of the siloxane is 5-30 wt %, and the content of the acrylate compound is 30-60 wt %.

3. The quantum dot ink according to claim 1, wherein the boiling point of the acrylate compound is greater than 150° C., and the boiling point of the siloxane is greater than 150° C.; and
optionally, the viscosity of the quantum dot ink at 25° C. is 3-50 cp.

4. The quantum dot ink according to claim 1, wherein the quantum dots contain organic ligand; and
in the quantum dots, by weight percentage, the content of the organic ligand is 5-60 wt %, preferably 8-50 wt %, and further preferably 10-30 wt %.

5. The quantum dot ink according to claim 4, wherein the organic ligand comprises:
at least one of oleamine, oleic acid, C6-C18 alkyl mercaptan, triphenylphosphine, triphenylphosphine oxide, sulfhydryl polyethylene glycol, sulfhydryl polyethylene glycol fatty acid ester, sulfhydryl polypropylene glycol, sulfhydryl polypropylene glycol fatty acid ester, sulfhydryl polyglycerol, sulfhydryl polyglycerol fatty acid ester, sulfhydryl-polyoxyethylene dehydrated sorbitol monolaurate, sulfhydryl-polyoxyethylene dehydrated sorbitol stearate, sulfhydryl-polyoxyethylene dehydrated sorbitol oleate, sulfhydryl-polyoxyethylene dehydrated sorbitol palmitate, or sulfhydryl-sorbitan fatty acid ester;
optionally, the organic ligand comprises at least one of the oleic acid, dodecanethiol or the oleamine; and in the organic ligand, by weight percentage, the content of the oleic acid is 20-100 wt %, the content of the oleamine is 0-50 wt %, and the content of the dodecanethiol is 0-50 wt %.

6. The quantum dot ink according to claim 1, wherein quantum dot main bodies of the quantum dots comprise at least one of a group II-VI compound, a group III-V compound, a group IV-VI compound, a group I-III-VI compound, a group I-II-IV-VI compound, a perovskite compound or carbon quantum dots; and
optionally, the particle sizes of the quantum dots are 1-50 nm, preferably 2-35 nm.

7. The quantum dot ink according to claim 1, wherein the siloxane comprises at least one of alkyl siloxane, aminopropyl siloxane, isocyanate-based siloxane, ethenyl siloxane, fluoropropyl siloxane, ethoxysiloxane, cyclosiloxane or silsesquioxane; and
optionally, the siloxane is selected from at least one of dodecyltriethoxysilane, cyclohexyl ethoxysilane, octaphenylcyclotetrasiloxane, dimethyl cyclosiloxane, methylsilsesquioxane, tetramethylcyclotetrasiloxane, octamethylcyclotetrasiloxane, tetraethoxysilane, aminopropyl-containing siloxane, isocyanate-based siloxane, allyl silsesquioxane, dihydroxy tetradecamethylheptasiloxane, octamethylcyclotetrasiloxane, methylvinylcyclosiloxane, methylphenylcyclotrisiloxane, trifluoropropylmethyl cyclotrisiloxane or methylvinylcyclosiloxane, and dimethyl cyclosiloxane, methyl-3,3,5-trifluoropropyl siloxane, phenylsilsesquioxane or dimethylsiloxane.

8. The quantum dot ink according to claim 1, wherein the acrylate compound comprises at least one of methyl acrylate, isobornyl acrylate, propanediol diacrylate or poly(ethylene glycol) diacrylate; and
optionally, the acrylate compound is selected from at least one of dodecyl methylacrylate, 2-methyl-2-adamantylmethacrylate, isobornyl methacrylate, tripropylene glycol diacrylate, poly(ethylene glycol) diacrylate, or cyclotrimethylolpropane methylal acrylate.

9. The quantum dot ink according to claim 1, the quantum dot ink further comprising an initiator, wherein
in the quantum dot ink, by weight percentage, the content of the initiator is 0.1-10 wt %; and
optionally, the initiator comprises photoinitiator and/or thermal initiator.

10. A method for preparing a color filter film, comprising the following steps:
a, adding the quantum dot ink according to claim 1 to a substrate; and
b, performing curing treatment on the quantum dot ink, so as to form a color filter film.

11. The method for preparing a color filter film according to claim 10, wherein
step b comprises: performing light curing on the quantum dot ink, so as to form a prefabricated film, and performing thermal treatment on the prefabricated film, so as to form the color filter film;
optionally, the temperature of thermal treatment is 25-300° C., preferably, 80-100° C.;
optionally, the time for thermal treatment is 30-120 min;
optionally, at least some of stages of thermal treatment are completed in an atmosphere containing water vapor; and
optionally, the atmosphere containing water vapor is an air atmosphere.

12. The method for preparing a color filter film according to claim 10, wherein the curing treatment is thermal curing;
the temperature of thermal curing is 80-150° C., preferably, 90-125° C.;
optionally, the time for thermal curing is 60-240 min;
optionally, at least some of stages of thermal curing are completed in an atmosphere containing water vapor; and
optionally, the atmosphere containing water vapor is an air atmosphere.

13. A color filter film, prepared by the method for preparing a color filter film according to claim 10.

14. The color filter film according to claim 13, the color filter film comprising polysiloxane microspheres, wherein the particle sizes of the polysiloxane microspheres are 200-600 nm.

15. A display device, comprising a color filter film, wherein the color filter film is the color filter film according to claim 13.

16. The quantum dot ink according to claim 2, wherein quantum dot main bodies of the quantum dots comprise at least one of a group II-VI compound, a group III-V compound, a group IV-VI compound, a group I-III-VI compound, a group I-II-IV-VI compound, a perovskite compound or carbon quantum dots; and
optionally, the particle sizes of the quantum dots are 1-50 nm, preferably 2-35 nm.

17. The quantum dot ink according to claim 3, wherein quantum dot main bodies of the quantum dots comprise at least one of a group II-VI compound, a group III-V compound, a group IV-VI compound, a group I-III-VI compound, a group I-II-IV-VI compound, a perovskite compound or carbon quantum dots; and
optionally, the particle sizes of the quantum dots are 1-50 nm, preferably 2-35 nm.

18. The quantum dot ink according to claim 4, wherein quantum dot main bodies of the quantum dots comprise at least one of a group II-VI compound, a group III-V compound, a group IV-VI compound, a group I-III-VI compound, a group I-II-IV-VI compound, a perovskite compound or carbon quantum dots; and
optionally, the particle sizes of the quantum dots are 1-50 nm, preferably 2-35 nm.

19. The quantum dot ink according to claim 5, wherein quantum dot main bodies of the quantum dots comprise at least one of a group II-VI compound, a group III-V compound, a group IV-VI compound, a group I-III-VI compound, a group I-II-IV-VI compound, a perovskite compound or carbon quantum dots; and
optionally, the particle sizes of the quantum dots are 1-50 nm, preferably 2-35 nm.

20. A display device, comprising a color filter film, wherein the color filter film is the color filter film according to claim 14.
